(19) United States
(12) Patent Application Publication
(10) Pub. No.: US 2026/0095077 A1
(43) Pub. Date: Apr. 2, 2026

(54) PROTECTION FOR ARMATURE OF ELECTROMAGNETIC LINEAR DRIVE

(71) Applicant: INDRIVETEC AG, Zürich (CH)

(72) Inventors: Martin VINZENS, Zürich (CH); Eric JULEN, Zürich (CH)

(73) Assignee: INDRIVETEC AG, Zürich (CH)

(21) Appl. No.: 19/113,019

(22) PCT Filed: Sep. 21, 2022
(86) PCT No.: PCT/EP2022/076259

§ 371 Date: Mar. 19, 2025

(51) Int. Cl. H02K 5/08; B61B 13/08; H02K 41/03

(52) U.S. Cl. CPC H02K 5/08; B61B 13/08; H02K 41/031; H02K 2205/12

(57) ABSTRACT

An electromagnetic linear drive for driving a track-guided vehicle along a rail system. The electromagnetic linear drive includes at least one stator segment arranged at the rail system and at least one magnet armature arranged at the vehicle. The at least one magnet armature includes a cover consisting of synthetic material comprising a meshwork of carbon fibers and/or aramid fibers. The electromagnetic linear drive can be used in a roller coaster for driving vehicles of the roller coaster.

### FIELD OF THE INVENTION

The present invention relates to an electromagnetic linear drive for driving a track-guided vehicle along a rail system; particularly an electromagnetic linear drive to accelerate passenger vehicles of a roller coaster or other amusement rides.

### BACKGROUND OF THE INVENTION

A linear drive or linear motor is an electromagnetic propulsion engine, which drives an object along a straight or curved course using magnetic forces resulting from magnetic fields. In contrast to common rotational electric drives, where a rotational force is generated by a steady stator and a rotor arranged at the rotating object, an armature is arranged at the moving object to interact with stator segments arranged along the course and generating a driving force when the object passes the stator segments.

A well-known application of such electromagnetic linear drives has been in roller coasters. Typically, roller coaster trains are catapulted every couple of minutes by an electromagnetic linear drive into a rail system made of steel. The roller coaster trains are heavy and receive their initial energy on a catapult track, which is for example about 50 meters long, by around 100 pairs of linear induction motors-commonly known as LIM. Such a LIM is a further development of the contactless acceleration systems based on the technology of rotational electric drives with the aim of being largely mechanically maintenance-free. LIMs are also used in mechanical drives of door systems-such as in supermarkets, for example-or in passenger conveyor belts and luggage belts at airports. LIMs have a limited efficiency due to eddy current losses and temperature losses.

For higher performance the linear induction motors are being replaced by linear synchronous motors-commonly known as LSM-whose efficiency is comparatively higher than that of the LIM. Leading providers of roller coasters often rely on powerful LSM acceleration coasters that can reach top speeds of around 180 kilometers per hour.

In general, the electromagnetic linear drive comprises stator coils that are placed along the linear course-like a rail system-and the armatures are arranged in a straight line at the vehicle. If a current is passed through the stator coils, a magnetic field is created around it. Its field strength depends on the applied current. In the electromagnetic linear drive, many such stator coils are connected in a row over an entire acceleration section or catapult section. The stator coils are grouped around a linear air gap. For example, the electromagnetic linear drive may have a length of about 1-5 meters along the course. A magnetically active armature is located along the vehicle as a reaction rail, which is pulled through the stator gap by the electromagnetic linear drive without contact. The functional principle of the drive follows the law of induction. An applied AC voltage generates a magnetic field in the stator coils that moves along the length of the stator group with a constant change of polarity between north and south. The traveling field moves along the acceleration section, its speed of travel is determined by the frequency of the applied current.

LIM systems commonly use for example copper or aluminium based armatures. The traveling magnetic field applied in the stator induces an electrical voltage in the armature rail, which sets the free electrons in the armature material in motion. This flow of electrons in turn creates a magnetic field. Both magnetic fields interact with each other, unlike poles attract each other, like poles repel each other. The interaction of the two magnetic fields creates a force component in the direction of the traveling field, which sets the vehicle in motion. In contrast to that, the armatures of LSM systems are commonly designed as a series of permanent magnets along the reaction rail which provide a constant magnetic field with alternating polarity. The armature magnetic field interacts synchronously with the traveling magnetic field generated by the stator group and generates a translational force; the armature is surfing on the magnetic waves of the stator group. The speed of the vehicle can be controlled synchronous to the speed of the travelling stator field.

EP 3 923 444 A1 discloses a known concept of an electromagnetic linear drive for accelerating a vehicle within an acceleration section of a travel course. The electromagnetic linear drive is particularly suitable for accelerating a vehicle for passenger transport in an amusement ride such as a roller coaster. The electromagnetic linear drive includes a stator with several pairs of stator elements arranged along a course section, the stator elements being combined into stator groups. Furthermore, the electromagnetic linear drive includes a magnet armature which is attached to the vehicle. For increased performance, the armature comprises a permanent magnet to achieve the accelerating forces. The stator groups are connected to energy converters for energy supply, which energy converters can be controlled individually. In this example, at least two of the stator groups are arranged in such a way that the magnet armature can interact simultaneously with these two stator groups.

Currently, electromagnetic linear drives allow for vehicle speeds up to 150-180 km/h. However, the demand for higher vehicle speed and acceleration, particularly for roller coasters, is continuously growing. The higher speeds, with the associated higher frequencies of the currents, cause higher eddy current losses in the components, especially in the magnet armatures mounted on the vehicle. Further, the higher speed causes temperature increases in the components of the electromagnetic linear drive, which result in an inefficient drive operation. As the magnetic forces during operation of the electromagnetic linear drives increase, magnetic armatures can attract dust or particles along the rail system, which may damage the stator segments during the next acceleration or deceleration phase of the vehicle.

It is known in the state of the art to use non-magnetic stainless steel hoods or aluminum hoods for the armatures. The stainless steel hoods serve, among other things, as mechanical protection. However, high eddy current losses may occur in the hood material which also cause an increase in temperature. Such temperature increases in the hoods can also increase the temperature of the armatures surrounded by the hoods. This, again, has a negative effect on the performance of the electromagnetic linear drive, particularly in case of permanent magnet LSM systems. Further, the high eddy current losses can have a negative impact on the partially safety-relevant, passive eddy current braking function of the drive.

DE 100 26 985 A1 discloses a LSM system with an armature unit, called secondary part, which comprises a carrier material made of carbon reinforced plastics, which provides an enclosure for permanent magnets of the armature. The permanent magnets are placed directly into the enclosure established at the secondary part and are casted therein. The secondary part made of carbon reinforced plastics and providing enclosures for the permanent magnets to be sealed therein, is meant to avoid a reduction of the driving forces of the linear synchronous drive. Further, it is meant to help avoiding a deformation of the secondary part, which results from transverse forces induced on the large surface area of the secondary part by the magnetic interaction with the primary part. However, designing the carrier material for the secondary part as a carbon reinforced plastics material requires further structural adaptions to the drive system, which may affect the qualities of the vehicle, first of all the safety of the vehicle. The permanent magnets cannot be accessed for maintenance of the electromagnetic linear drive once they are cast into the enclosures of the secondary part.

The use of fiber reinforced plastics is further known for rotational electric drives, wherein the mounting of magnets at the rotors gets more and more problematic with increasing rotational speed of the rotors due to centrifugal forces acting on the rotor magnets. For example, in U.S. Pat. No. 6,452,301 B1 the radial retention of the rotor magnets and slotted wedges between them is ensured by surrounding the entire cylindrical outer surface of the rotor with an outer sheath consisting of a fiber reinforced organic or inorganic polymer composite. The composite is made by dry-laying resin transfer and wet or prepreg filament processes. In this way, the composite outer shell forms a containment wall that counteracts the centrifugal forces generated by the magnets and wedges and allows for higher rotational speed. Again, in such an embodiment the magnets are not accessible and mounting of the protection sheath on the magnets is complicated and costly. Therefore, such a solution is suitable for small rotational electric drives. It is not applicable for electromagnetic linear drives having magnetic armatures designed as large elongated reaction rails, wherein the magnets are subjected to linear translational forces but not to rotational acceleration creating centrifugal force.

### SUMMARY OF THE INVENTION

It is an object of the present invention to provide an electromagnetic linear drive and a cover for an armature of the electromagnetic linear drive that improves the efficiency of the drive, particularly reduces eddy current losses during the operation of the drive, provides a stable, light weighted and flexible constructions and allows for cost-efficient production. Particularly, it is an object of the present invention to provide a roller coaster with an electromagnetic linear drive that withstands the wear and tear during operation and improves the performance of the roller coaster.

According to the present invention, these and further objects are achieved, particularly, by an electromagnetic linear drive for driving a track-guided vehicle along a rail system, an armature cover for such an electromagnetic linear drive and a roller coaster with such an electromagnetic linear drive comprising the features of the independent claims. In addition, further advantageous embodiments can be derived from the dependent claims and the related descriptions.

According to an aspect of the present invention, an electromagnetic linear drive for driving a track-guided vehicle along a rail system is provided that comprises at least one stator segment arranged at the rail system and at least one magnet armature arranged at the vehicle. The stator segment of the electromagnetic linear drive can be realized as a stator section of the rail system guiding the vehicles. For example, the stator segment can be realized as a group of stator pairs lined up along an elongated section of the rail system and providing a gap for receiving the magnet armature. The group of stator pairs generates a magnetic field that moves along the length of the stator segment with a constant change of polarity and that interacts with the magnet armature arranged at the vehicle. In case the electromagnetic linear drive is an LIS system the magnet armatures can be realized by induction units, for example made of copper or aluminium, which are stimulated by the alternating magnetic field of the stator segment. In case the electromagnetic linear drive is an LSM system the magnet armatures can be realized as permanent magnets lined up with alternating polarity along the vehicle and interacting with the alternating magnetic field of the stator segment. In both cases the magnet armatures define an elongated reaction rail interacting with the stator segment. For example, the stator segment at the rail system may include 4-50 stators and the reaction rail at the vehicles may include 1-50 magnet armatures.

According to the present invention the at least one magnet armature comprises a cover consisting of synthetic material comprising a meshwork of carbon fibers and/or aramid fibers. The cover provides a mechanical protection for the at least one magnet armatures. The synthetic material does not interact with the electric currents and magnetic fields used in the electromagnetic linear drive. It avoids the occurrence of eddy current losses and increases efficiency of the electromagnetic linear drive. Carbon fibers have advantageous physical properties to support the synthetic material of the cover. Carbon fibers are extremely strong, have a high heat conductivity, a high chemical resistance and low thermal expansion. Aramid fibers are tough and flexible, not electrically conductive, have a high abrasion resistance and low flammability. Providing carbon fibers and/or aramid fibers as a meshwork further reinforces the stability and rigidity of the cover without adding a lot of weight to the synthetic material. Despite the light weight of the cover, it is strong enough to prevent the magnet armature from any damaging impacts during the fast ride of the vehicle along the rail system. Particularly, in the case of permanent magnet armatures the cover provides excellent protection since permanent magnets are made of brittle material which easily corrodes like rare earths. Further, it protects the stator segment because the synthetic material with the fiber meshwork of the cover reduces the likelihood that the magnet armature picks up particles along the ride and carries it into the stator segment since the cover is not magnetic itself. During the acceleration phase of the electromagnetic linear drive the covers do not increase temperature like commonly used metal hoods, and therefore no cooling system for cooling the magnet armature protection is required. The shape of the cover may be adapted to match the shape of the at least one magnet armature. Alternatively, the size of the cover may be chosen to cover several or all of the magnet armatures of a reaction rail.

According to a further aspect of the present invention, a magnet armature cover for an electromagnetic linear drive as described herein is provided.

According to a still further aspect of the present invention, a roller coaster comprising an electromagnetic linear drive as described herein is provided.

The carbon fiber and/or aramid fiber meshwork of the synthetic material of the cover for the magnet armature can for example be realized by an arbitrary arrangement of fibers within the synthetic material. Preferably, the fibers are at least nearly uniformly distributed in the synthetic material with only little variability in the number of fibers per area. In an advantageous variant, the fiber meshwork is realized by a cross pattern of fibers, wherein fibers extending in a first direction cross with fibers extending in a second direction which is angled to the first direction. Of course, there can be fibers extending in a third or further direction which is angled to the first and the second direction. For example, the meshwork may comprise at least one first layer of at least nearly parallel fibers extending in the first direction and at least one second layer of at least nearly parallel fibers extending in the second direction and overlapping with the first layer. The layers can be realized as fiber sheets. Several sheets may be successively offset to each other along the length of the cover which results in extending the surface area covered by sheets. Also, the fiber meshwork can be realized by a woven meshwork wherein carbon fiber strings are interwoven to form a grid or woven fabric.

The meshwork of the electromagnetic linear drive comprises carbon fibers and/or aramid fibers, for example plain carbon fibers or plain aramid fibers. Further, the meshwork of the synthetic material may be realized by a mixture of carbon fibers and aramid fibers. Aramid fibers contribute to the overall advantageous physical properties of the cover because it has different physical properties than carbon. The aramid fibers can offset for the low mechanical stability of the carbon fibers and compensate for the electrical conductivity of carbon. A meshwork comprising a mixture of carbon fibers and aramid fibers may enhance the protection of the magnet armatures and increases the efficiency of the electromagnetic linear drive.

In a variant of the carbon/aramid fiber meshwork the ratio of carbon fibers and aramid fibers in the mixture is in the range of 0:1 to 1:0. These mixing ratios maximize the utilization of the advantageous properties of each type of fiber while impacts of properties contributing less to the object of the cover are minimized.

According to a further embodiment of the present invention, the cover comprises a thickness between 2.0 mm and 0,5 mm, preferably between 1,2 mm and 0,8 mm, advantageously 1,0 mm. This thickness allows for incorporating a strong fiber meshwork structure in the synthetic material of the cover and does not impact the design of the magnet armatures for the layout of the electromagnetic linear drive.

In one embodiment variant of the electromagnetic linear drive according to the present invention the magnet armature is attached at a surface of the vehicle and the cover is attached over the magnet armature to the surface of the vehicle. The magnet armature can be fixed to the vehicle surface in a conventional manner, for example using screws or the like. The magnet armature may also be attached to the vehicle surface using a holder integrated in the surface. The cover is attached separately from the magnet armature to the vehicle surface and encloses the magnet armature. The cover can be fixed to the surface in a conventional manner, for example using screws or the like. Advantageously the cover comprises one side open, which is closed by attaching the cover to the surface of the vehicle.

In an alternative embodiment variant of the electromagnetic linear drive according to the present invention the cover fully covers the magnet armature and/or the magnets are casted inside the cover. Thus, the magnet armature and the cover build a unit that can be attached and detached from the vehicle for easy replacement or inspection of the magnet armature. The cover may have a form fit adapted to the form of the magnet armature. Also, the magnet armature may be hold in a press fit in the cover. To do so the interior of the cover may include compressible holding elements that are shaped according to the outer contour of the magnet armature when the magnet armature is pressed into the cover interior. Also, the cover may receive more than one magnet armature.

According to a still further embodiment of the present invention the cover may be sealed for example by synthetic resin. The sealing protects the interior of the cover against moisture. The synthetic resin can be applied only to seams of the synthetic material and/or connections of the magnet armature unit to completely seal any possible access to the cover interior. Or, all of the free space between the magnet armature and inner walls of the cover may be sealed by synthetic resin. For example, the entire interior can be completely filled with sealant material or a potting material by vacuum filling. In this case the magnet armature and the cover are designed as a block unit that does not have any vacant space for absorbing moisture. Further, the block structure leads to increased mechanical stability. Several block units can then be attached to the vehicle to realize the reaction rail.

In an advantageous embodiment of the present invention the electromagnetic linear drive according to the invention is designed as a linear synchronous motor. Preferably, the magnet armature is realized as a permanent magnet and a group of magnet armatures is arranged in line at the vehicle, wherein each of the magnet armatures comprises a cover consisting of synthetic material comprising a carbon fiber or a carbon/aramid fiber meshwork. The cover made of synthetic material with a carbon fiber or a carbon/aramid fiber meshwork is particularly beneficial for LSM systems with elongated reaction rails at the vehicles. The shape of the cover can easily be adapted to the shape of the permanent magnets of the LSM, even to the shape of individual attachment areas at the vehicle. The cover protects the heavy permanent magnets without adding significant additional weight and is strong enough to keep the magnets safe and in place.

However, the cover consisting of synthetic material comprising a carbon fiber, an aramid fiber or a carbon/aramid fiber meshwork is also suitable for LIM systems using for example electromagnets for the magnet armatures. The cover does not contribute any significant eddy currents and protects the magnet armatures from negative temperature impacts.

In summary, the magnet armature cover made of carbon or carbon/aramid mixture braids reinforced plastic or synthetic material renders the electromagnetic linear drive more efficient and extends its longevity. This choice of material makes it possible to make mechanically very stable and light covers, which are also non-magnetic and only allow very little or no eddy currents to form. This results in stable mechanical protection for the magnet armatures covered by the cover, particularly for permanent magnets which are sensitive to shocks and impacts because they are made of brittle materials. The massively reduced eddy current losses in the cover increase motor efficiency and safety. These new covers can be installed tightly on the vehicle base carrier holding the permanent magnets and can be sealed to prevent moisture inside the covers.

### BRIEF DESCRIPTION OF THE DRAWINGS

An exemplary embodiment of the invention will be illustrated in the following drawings, which merely serve for explanation and should not be construed as being restrictive. The features of the invention becoming obvious from the drawings should be considered to be part of the disclosure of the invention both on their own and in any combination. The drawings show:

FIG. 1 a schematical diagram of a cover for a magnet armature of a electromagnetic linear drive according to the present invention, and

FIG. 2 a schematical diagram of an electromagnetic linear drive according to the present invention illustrating a stator segment and a reaction rail of the electromagnetic linear drive.

### DETAILED DESCRIPTION OF THE PREFERRED EMBODIMENTS

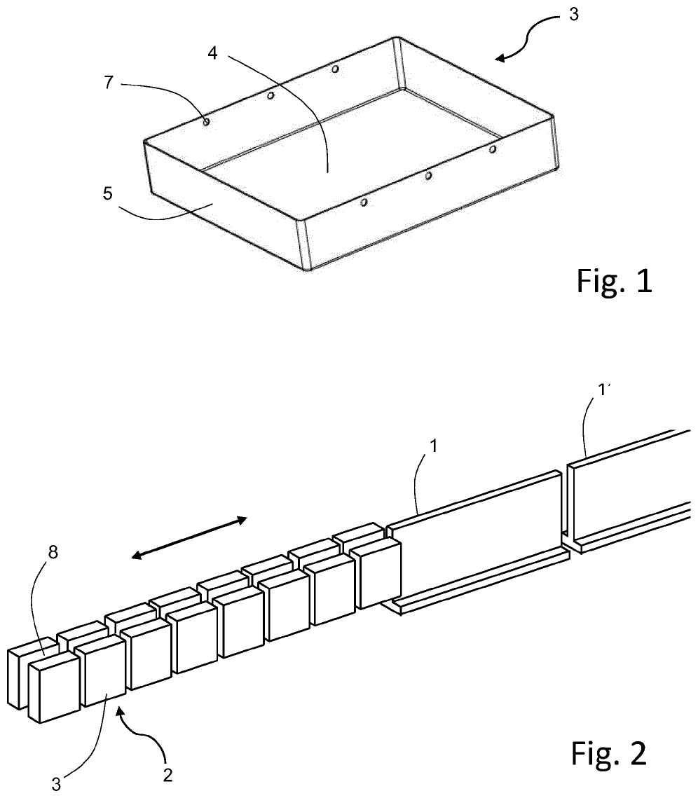

The present invention provides an electromagnetic linear drive for driving a track-guided vehicle along a rail system comprising at least one stator segment 1 arranged at the rail system and at least one magnet armature 2 arranged at the vehicle. The magnet armature 2 comprises a cover 3, as illustrated in FIG. 1, made of synthetic material comprising a carbon fiber and/or aramid fiber meshwork. FIG. 2 shows by way of example two stator segments 1 and 1′ and a series of magnet armatures 2 covered by covers 3.

For simplicity, further components of the installation and the system of the electromagnetic linear drive like the vehicles, the rail system or a control system are omitted in the Figures. An electromagnetic linear drive according to the invention can for example be based on the teachings as disclosed in EP 3923444 A1. Any specification of features of the electromagnetic linear drive disclosed therein shall be part of the present specification of the electromagnetic linear drive according to the present invention.

The example embodiment of the cover 3 for the magnet armature as shown in FIG. 1 comprises a square shape with a large bottom surface 4 and narrow circumferential surfaces 5. The top side of the cover can be open and can be closed after the magnet armature is located inside the cover. It is noted, that the expressions “top” and “bottom” refer to the orientation of the cover as illustrated in FIG. 1 and should not be interpreted as a limiting feature of the cover. In another perspective view of the cover, the bottom surface might be at the top and the bottom might be open. The volume of the cover 3 is adapted to the outer contour of the magnet armature to be enclosed by the cover. Along the upper rim, the circumferential surfaces 5 comprise through holes 7 which can be used for fixation means like screws for fixing the magnet armature inside the cover and/or for attaching the cover with the magnet armature inside to the vehicle. Further the through holes 7 could be used for inject sealing material into the interior of the cover.

Once the magnet armature is located inside the cover, they can be attached to the vehicle as a unit, wherein a surface of the vehicle serves as an attachment surface. The cover can fully enclose the magnet armature or the cover can be closed by attaching the magnet armature to the vehicle. The edges of the circumferential surfaces 5 resting on the vehicle surface can be sealed and/or the interior of the cover can be filled with sealing material and/or potting material through the through holes 7 for sealing.

The surfaces of the cover consist of synthetic material comprising a fiber meshwork or an aramid fiber meshwork or a meshwork of a mixture of carbon fibers and aramid fibers. The cover may for example be produced by using a casting mold determining the shape of the cover and adding the fiber meshwork and the synthetic material into the casting mold as it is commonly known.

FIG. 2 schematically illustrates the arrangement of the stator segments 1 and l′ and a group of magnet armatures 2 of the electromagnetic linear drive. Each of the magnet armatures comprises a cover as described above. The magnet armatures 2 are arranged in pairs to provide a gap 8 between them. Further, the magnet armatures 2 are arranged in line at the vehicle (not shown). The group of pairs of magnet armatures 2 defines a reaction rail of the electromagnetic linear drive. The stator segments 1 and 1′ are attached in series along the rail system that serves as a guide for the vehicles carrying the magnet armatures 2. For driving the vehicle comprising the magnet armatures 2, the vehicle is positioned or runs over the stator segments 1 and 1′. The stator segments 1 and 1′ pass through the gap 8 between the pairs of magnet armatures 8. The alternating magnetic field travelling along the stator segments 1 and 1′ as described above interacts with the alternating magnetic field generated by the group of magnet armatures 2 and induces an acceleration force to the vehicle.

A roller coaster as described in the international patent application number PCT/EP2022/072383 of the applicant may serve as the basis for a roller coaster according to the present invention. The features of the roller coaster as described therein shall be incorporated into the present specification. A rail system is provided on a support structure which is made up of a number of elongate support elements. The support elements are set up essentially perpendicularly on a base on which the roller coaster is set up. On the rail system, a vehicle is shown as an example, which can consist of several individual cars. The roller coaster has a linear synchronous drive. For this purpose, a multiplicity of stators are arranged on the rail system along the rails forming a stator segment and a multiplicity of magnet armatures are arranged on the vehicle, which generate a driving force for the vehicle by induction. The roller coaster also has a central control unit, which controls the driving operation of the linear synchronous drive, and an energy supply system for providing energy for the linear synchronous drive and the control system. According to the present invention each of the magnet armatures of the roller coaster comprises a cover consisting of synthetic material comprising a carbon fiber or aramid fiber meshwork or a meshwork of a mixture of carbon fibers and aramid fibers as described above.

In the patent claims the word “comprising” and “consisting” does not exclude other elements, and the indefinite article “a” or “an” does not exclude a plurality. A single unit step may fulfil the functions of several features recited in the claims. The mere fact that certain features are recited in mutually different dependent claims does not indicate that a combination of these features cannot be used to advantage. Any reference signs in the claims should not be construed as limiting the scope.

### Reference Signs

1,1′ Stator segment
2 Magnet armature
3 Cover
4 Bottom surface
5 Circumferential surfaces
6 ———
7 Through holes
8 Gap

1. An electromagnetic linear drive for driving a track-guided vehicle along a rail system comprising at least one stator segment arranged at the rail system and at least one magnet armature arranged at the vehicle, wherein the at least one magnet armature comprises a cover consisting of synthetic material comprising a meshwork of carbon fibers and/or aramid fibers.

2. The electromagnetic linear drive according to claim 1, wherein the meshwork is realized by a mixture of carbon fibers and aramid fibers and a ratio of carbon fibers and aramid fibers in the mixture is in the range of 0:1 to 1:0.

3. The electromagnetic linear drive according to claim 1, wherein the cover is sealed by a synthetic resin.

4. The electromagnetic linear drive according to one claim 1, wherein the cover comprises a thickness between 2.0 mm and 0.5 mm.

5. The electromagnetic linear drive according to one claim 1, wherein the at least one magnet armature is designed for attachment at a surface of the vehicle and the cover is designed for attachment to the surface of the vehicle and over a magnet armature.

6. The electromagnetic linear drive according to claim 1, wherein the cover fully covers a magnet armature.

7. The electromagnetic linear drive according to claim 1, wherein the cover is holding a magnet armature and comprises one side open, which is closed by attaching it to a surface of the vehicle.

8. The electromagnetic linear drive according to claim 1, wherein the at least one magnet armature is realized as a permanent magnet.

9. The electromagnetic linear drive according to claim 1, wherein a group of magnet armatures is arranged in line at the vehicle and each of the magnet armatures comprises a cover.

10. The electromagnetic linear drive according to claim 1, wherein the linear drive is a linear synchronous motor.

11. A magnet armature cover for an electromagnetic linear drive according to claim 1.

12. A roller coaster comprising the electromagnetic linear drive according to claim 1.

13. The electromagnetic linear drive according to claim 1, wherein the cover comprises a thickness between 1.2 mm and 0.8 mm.

14. The electromagnetic linear drive according to claim 1, wherein the cover comprises a thickness of 1.0 mm.
